(19) United States
(12) Patent Application Publication
(10) Pub. No.: US 2008/0208867 A1
(43) Pub. Date: Aug. 28, 2008

(54) METHOD AND SYSTEM FOR INVITATIONAL RECRUITMENT TO A WEB SITE

(75) Inventors: Timothy Poston, Bangalore (IN); Tomer Shalit, Holmsund (SE); Mark Dixon, Skarholmen (SE)

Correspondence Address: ALBIHNS STOCKHOLM AB, BOX 5581, LINNEGATAN 2, SE-114 85 STOCKHOLM; SWEDENn, STOCKHOLM, omitted

(73) Assignee: PADO METAWARE AB, Umea (SE)

(21) Appl. No.: 12/037,130

(22) Filed: Feb. 26, 2008

Related U.S. Application Data
(60) Provisional application No. 60/891,534, filed on Feb. 26, 2007.

(51) Int. Cl. G06F 17/30

(52) U.S. Cl. 707/9; 707/E17.007

(57) ABSTRACT

A current registered member of a web site is enabled to send a message to a person not currently a member, containing a link to a newly created membership page for that person, to which access may be confirmed by only the entry of a password, rather than a multi-step registration process, or may be extended by the use of a cookies or the mailing of repeated single-use keys. The new membership includes the ordinary privileges of a non-paying member of the site, together with access to site aspects specific to the inviter and the creation of the invitation, such as but not limited to folders created by the inviter, documents or other files uploaded by the inviter, blogs or postings by the inviter, alerts as to future events initiated by the inviter, information about purchasable items recommended by the inviter, free access to documents or other viewable entities for which the inviter has purchased access, or a family tree presented from the viewpoint of the invitee.

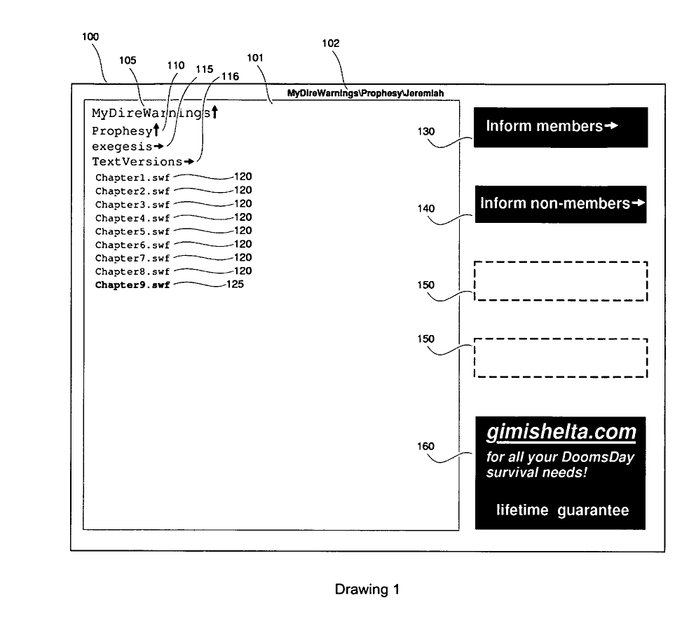

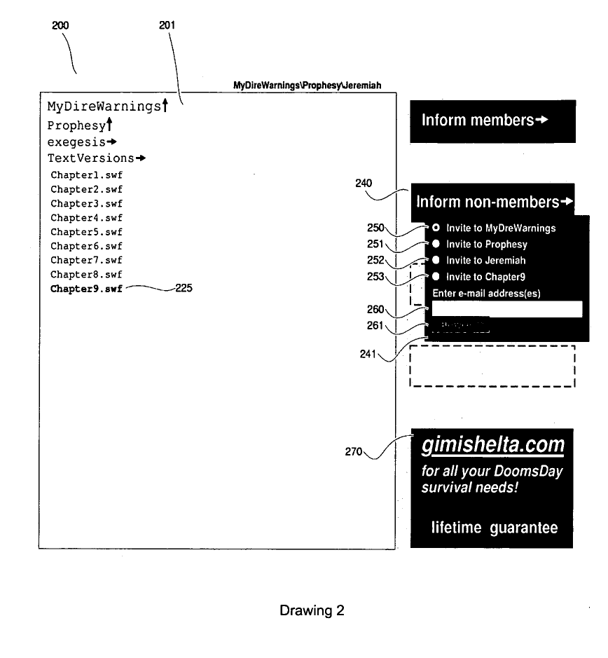

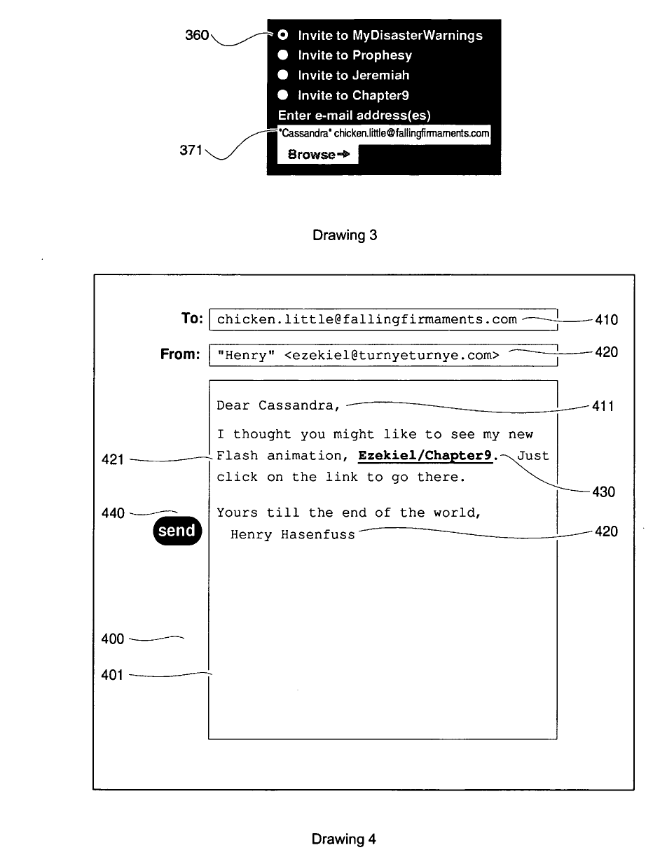

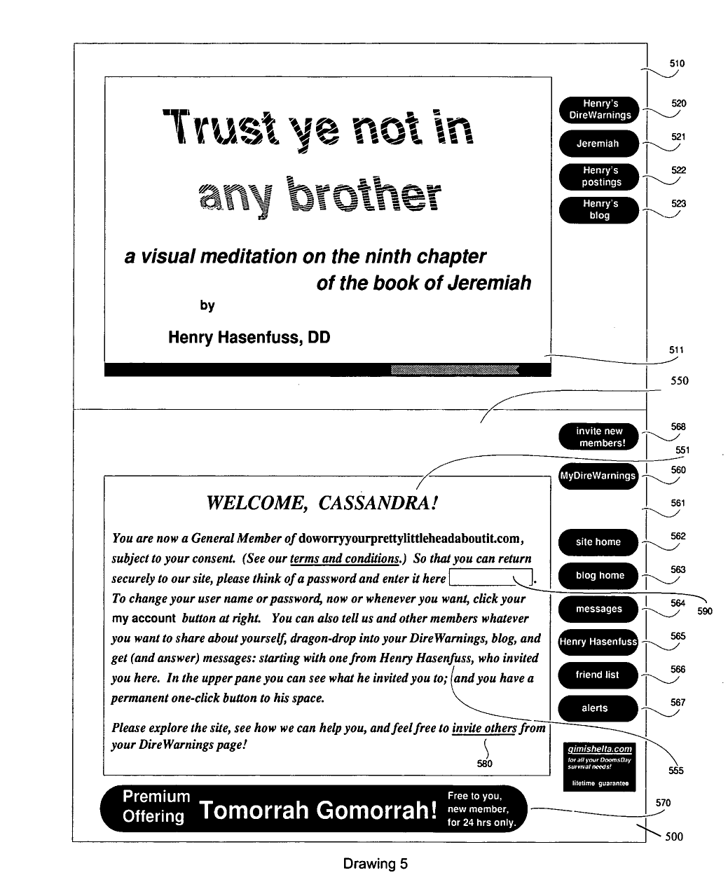

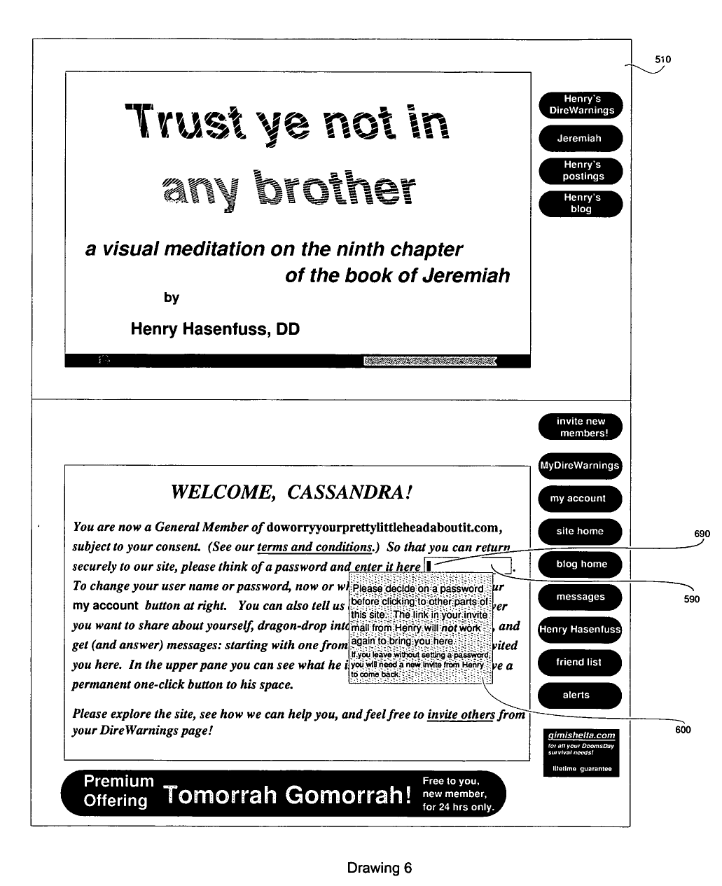

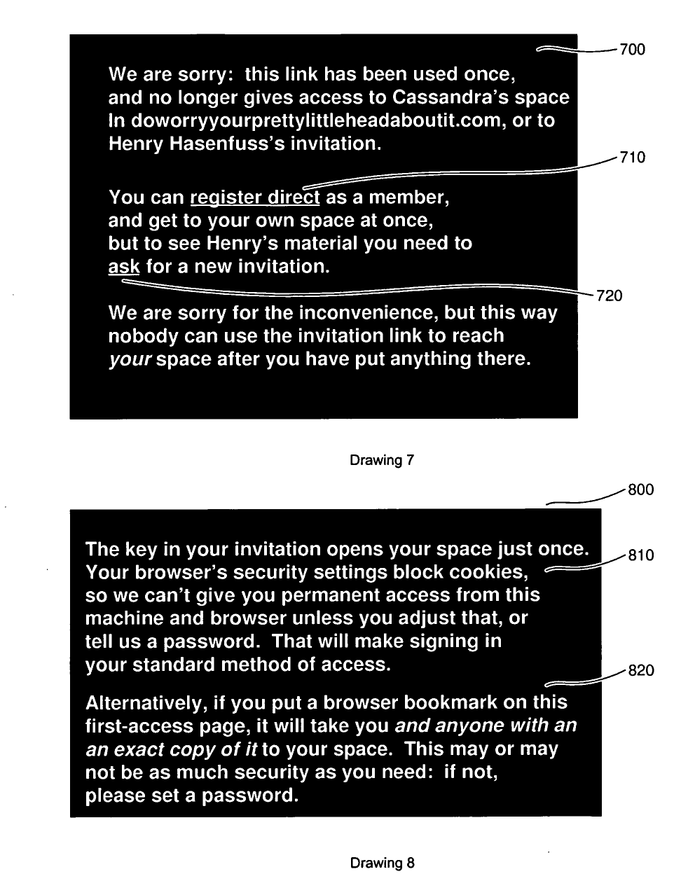

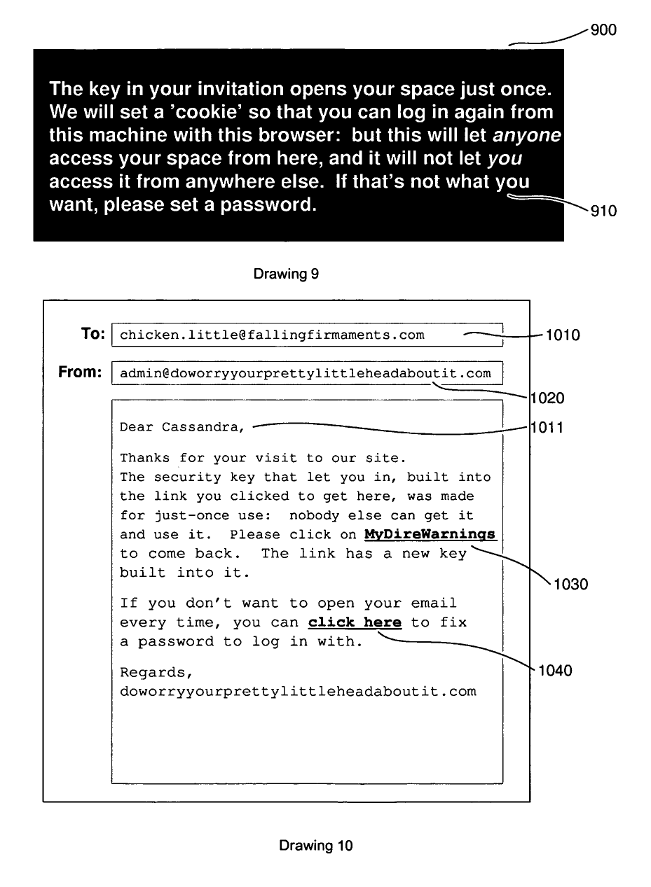

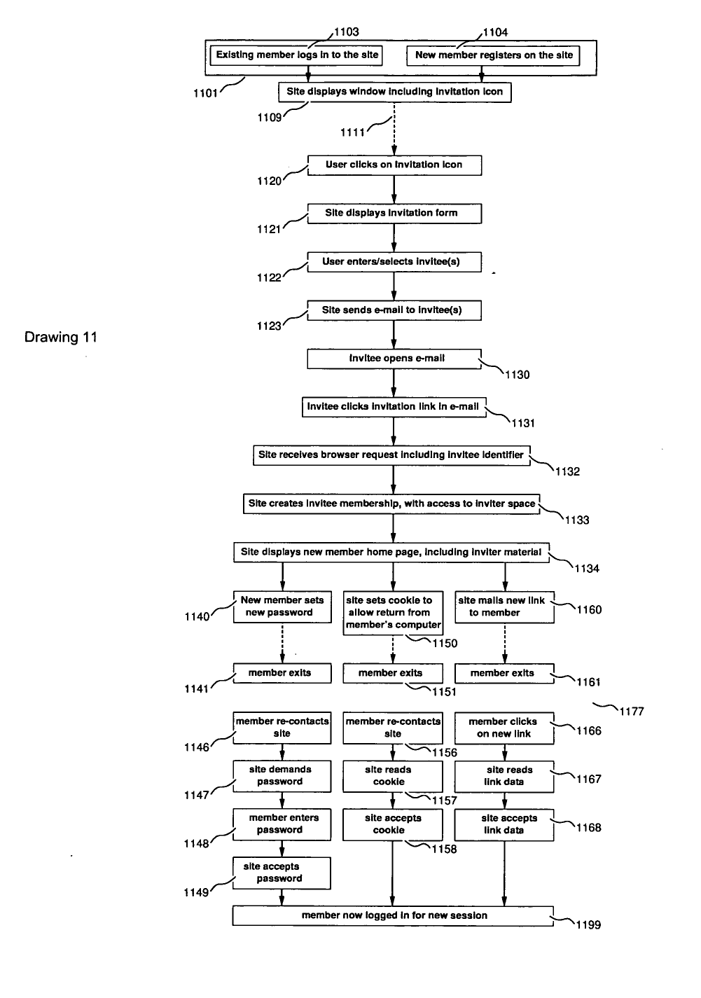

### BACKGROUND OF THE INVENTION

Many web sites have some form of ‘membership’ for users. Sales sites store the addresses, credit card details and buying history of repeat customers. Sites offering news, recipes, special images or communication with other users, invite readers to join. A typical sign-up page has instructions like “To register your details please fill in the simple and quick form below. By registering with us you'll get access to a wide range of recipes and the opportunity to receive a monthly newsletter keeping you up to date on all of our news, hints and tips, new products and recipes.” This is indeed simple and quick, by comparison with many sites, but it asks for “Full name*: E-mail*: Telephone: Company name*: Company address*: Postcode*: Business Type*: Trade Sector:” with all starred items being “required”, and the user must check “I agree to the Terms and Conditions”, adding to user unease. Some sites demand less information. (There is no reason for a recipe user to say what business he is in, except that a profile of the membership makes it easier for the site to sell advertising space.) Some ask for far more, page upon page of research interests, income, age, fetishes, hobbies, gender, language(s) spoken, buying habits, etc. Many ask for credit card details, even where the user has not yet declared an intent to spend money. A multi-page registration process rarely announces its length in advance, just giving a sequence of “Next” or “Continue” buttons, so the user learns to think of registration as a blank check on her time.

Some of these demands come from commercial avidity. No less often, a database designer thinks about what the system could do if it knew X, Y and Z, and so designs it to ask about X, Y and Z, without considering the time, commitment level, trust and keyboard effort demanded of the user. (“I am entering stuff into the computer all day, why shouldn't the users?” says the programmer. Many users are still uneasy even to be using a keyboard, and unwilling to spend time on the learning curve to join a site which has not yet shown them its advantages.)

In some cases the user arrives by search, knowing almost nil about the site. In cases more of interest for the present invention (such as a site where people upload their photographs, and invite their friends to look at them) the advantages of joining are clearer, but still the Become A Member! box shows or leads to an intimidating questionnaire. A typical invitation message reads as follows:

From: noreply@googlegroups.com
To: geometre@yahoo.co.uk

### Date: Fri, 15 Dec 2006 02:49:26 +0000

Subject: Google Groups: You've been invited to Ranga Shankara Bangalore Ranga Shankara zubinsaigal@gmail.com has invited you to join the Ranga Shankara Bangalore group with this message:
Here is the group's description:

### Ranga Shankara Theatre, JP Nagar, Bangalore—

### ---------------------- Google Groups Information ----------------------

You can accept this invitation by clicking the following URL:
http://groups.google.com/group/rsblr/sub?s=k5MycwgAAACw9nEEwZm3rbfFRKBxmEle
Access to the group on the web requires a Google Account. If you don't have a Google Account set up yet, you'll first need to create an account before you can access the group. You can create an account at:
http://www.google.com/accounts/NewAccount?service=groups2&dEM=geometeer%40yahoo.co.uk&continue=http%3A%2F%2Fgroups.google.com%2Fgroup%2Frsblr

The addressee is asked to join a particular group (this one simply for theater announcements) and see its contents; but a non-member of the group-supporting website must separately go through an account creation process—also called ‘registration’—before getting a look at the group.

From seeing what somebody else is doing with membership of the site, to joining and using it oneself, the transition has a significant psychological barrier, not the less real because some percentage of site visitors overcome it, and join the site. The aim of the present invention is to lower that barrier, and raise this percentage. In some embodiments it reduces the registration effort the invitee is asked to make, in others it eliminates it completely, and in all cases it shows (rather than describes) the advantages of membership before asking the invitee to step though a registration process.

### BRIEF SUMMARY OF THE INVENTION

A current registered member of a web site is enabled to send a message to a person not currently a member, containing a link to a newly created membership page for that person, to which access may be confirmed by the creation of a password, rather than a multi-step registration process, or may be extended without passwords by use of a cookies or the mailing of repeated single-use keys. The new membership includes normal privileges of a non-paying member of the site, together with access to site aspects specific to the inviter and the creation of the invitation, such as but not limited to folders created by the inviter, documents or other files uploaded by the inviter, blogs or postings by the inviter, alerts as to future events initiated by the inviter, information about purchasable items recommended by the inviter, free access to documents or other viewable entities for which the inviter has purchased access, or a family tree presented from the viewpoint of the invitee.
The invention relates to a method for invitational recruitment to a web site over a network, under control of a computer system, comprising the steps of
   providing an existing member of the web site with an inviting arrangement for inviting a non-member to join the web site wherein the inviting arrangement comprises an input arrangement wherein the existing member is enabled to enter non-member data;
   entering non-member data to be used to establish a communication with the non-member;
   sending a first message to the non-member, containing a web link to a member page for the non-member, using the entered non-member data;
   creating a provisional member ID for the non-member based on the non-member data, enabling access for the non-member to the member page; and
   storing the provisional member ID at the computer system.
An embodiment discloses a method wherein the method further comprises the step of:
   setting a parameter that must be fulfilled such that access to the member page is limited to a request that fulfills the set parameter
   activating the link wherein a second message is created comprising a browser request with the address of the link along with the non-member data,
   transferring the second message to the web site,
   identifying sender of the second message using the provisional member ID to allow access to the member site, and
   displaying the member site if the second message fulfils the set parameter.
An embodiment discloses a method wherein the parameter to access the member page comprises a limit of times to use the link.
An embodiment discloses a method wherein the parameter to access the member page is a password.
An embodiment discloses a method wherein the non-member data comprises an email address of the non-member.
An embodiment discloses a method where the inviting arrangement comprises a second input arrangement wherein the existing member is enabled to specify at least one privileges beyond a basic membership in the site that will be afforded to the non-member.
An embodiment discloses a method where one privilege gives access to at least one folders created by the existing member, allowing reading or download of data in the folders.
An embodiment discloses a method where one privilege includes enabling the non-member to download access to material uploaded or posted by the existing member, or to which the existing member has access.
An embodiment discloses a method where one privilege includes sharing in access paid for by the existing member to existing material on the site.
An embodiment discloses a method where material on the server of the web site is shown to a user by icons in a window that appears and is controlled as a folder in the user's local file hierarchy.
An embodiment discloses a method wherein instructions, specific to the folder in a user's local file hierarchy, appear in its menus and bar.
An embodiment discloses a method where one privilege includes sharing in genealogical data assembled by a group of which the existing member is a member.
An embodiment discloses a method where the members of the web site may install a thin client on their own machines for improved interaction with its services.
An embodiment discloses a method where in the step of entering the non-member data also comprises that the inviter specifies certain options available to basic members to which the non-member is to be specifically directed upon first entry.
An embodiment discloses a method where after the link is used a specified number of uses indicated by the parameter the link opens only to a page leading to an invitation to register directly, and optionally to a request for a new invitation.
An embodiment discloses a method where the site confirms the non-member's consent by obtaining a password chosen by the non-member.
An embodiment discloses a method where after one use the link becomes invalid, but a message with a new single-use link is sent to the user to whom the link was sent, permitting access without a password to the user's space on the site.
An embodiment discloses a method where after one use the link becomes invalid, but use of a cookie permits repeated access without a password to the user's space on the site when using the same machine and browser.
An embodiment discloses a method where the window first appears to the user within a browser, from which the user is enabled to transfer it (visually and interactionally unchanged) to a position in the local file hierarchy.
The invention further relates to a database comprising a memory arrangement containing a web site, so arranged as to enable the database to be connected via a network to a computer of a member of a web site, and a control unit, wherein the control unit is arranged to, when running an application from the memory arrangement,
   provide an existing member of the web site with an inviting arrangement configured to invite a non-member to join the web site wherein the inviting arrangement comprises an input arrangement wherein the existing member is enabled to input non-member data to be used to establish a communication with the non-member;
   send a first message to the non-member, containing a web link to a member page for the non-member, by using the entered non-member data;
   create a provisional member ID for the non-member based on the non-member data, wherein the provisional member ID is arranged to enable access for the non-member to the member page;
   set a parameter value that needs to be fulfilled to enable the access to the member page; and
   store the provisional member ID along with the set parameter in the memory arrangement.
In an embodiment the control unit is further arranged to check whether a received request fulfils the parameter and to provide access to the member's page.
In an embodiment the parameter is set to be or include a maximum number of activations of the web-link and/or a password.
The invention further discloses a computer program product including a computer usable medium having computer program logic stored therein to enable a computer system to perform the steps of offering an existing member of a web site an inviting arrangement to invite a non-member to join, by entering email data for the non-member, sending an e-mail to the non-member, containing a web link to a member page for the non-member, and using the email data of the non-member to create a provisional member ID for the non-member enabling access to the member page.

### BRIEF DESCRIPTION OF THE DRAWINGS

Drawing 1: A representative screen from which a member may initiate an invitation.

Drawing 2: The same screen, with a menu by which the member sends the invitation.

Drawing 3: Entry of the invitee's name in the sub-menu from Drawing 2.

Drawing 4: A representative invitation e-mail received by the invitee.

Drawing 5: A welcome screen for the invitee, with access to the inviter's material.

Drawing 6: A screen requiring a password selection step to proceed further.

Drawing 7: A screen presented upon a second attempt to use the first invitation.

Drawing 8: A box presented if the site seeks unsuccessfully to maintain access by cookies.

Drawing 9: A box presented if the site can maintain access by cookies, presenting options.

Drawing 10: An email providing a new single-use key.

Drawing 11: A logical flow chart of embodiments of the invention.

### DETAILED DESCRIPTION OF THE INVENTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that several blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

We illustrate with a fictitious site named doworryyourprettylittleheadaboutit.com, where users come together about a threat of face spots, sun spots, night spots, hot spots, sore spots, loss of software diversity, or any other danger facing their planet. A member can enter messages that become readable to others, and upload files of diagrams, numerological simulations, documents, music or video, and so on. The member places such a message or file in a list to which all members have access, or to which a certain group or groups of members, or one or more specific members have access. The member may buy products, such as the doworryyourprettylittleheadaboutit T-shirt, from the site. The member may search the site, and may send messages to another member, seen when that member logs in to doworryyourprettylittleheadaboutit.com, or (if permissions are set) by email or via a connection to the other member's mobile phone. Some services are free; others are ‘premium’ offerings for payment. We assume that doworryyourprettylittleheadaboutit.com offers free (i) a limited amount of disk space in a folder called MyDireWarnings, where uploaded files are searchable and readable to other members, (ii) read access to messages posted by other members in discussions, but not the ability to post, (iii) writing in a web-log readable by others, but not reading others' logs uninvited, (iv) search and read access to files uploaded by others, but not download uninvited, and (v) the ability to receive and reply to messages sent individually by other members, though not to initiate contact. Any member may purchase merchandise, and will then receive a bonus of premium membership if there is an R in the month. Such services exemplify a mix that may be offered by a membership-oriented web site, as is clear to those skilled in the art. The present invention consists of a system and method for invitational recruitment to any site that offers services such as, but not limited to, those just described.

We illustrate the invention for the case of a member Henry Hasenfuss, whose email address is ezekiel@turnyeturnye.com. He has created a Flash animation of the ninth chapter of the book of Jeremiah, complete with Jerusalem as a den of dragons, and uploaded it to his MyDireWarnings space 100 (Drawing 1) in doworryyourprettylittleheadaboutit.com; within that, specifically to 101 the subfolder Jeremiah of the folder Prophesy, in his MyDireWarnings space This subfolder 102 shows links (here, a ‘to my home space’ clickable 105 MyDireWarnings ↑, a ‘next level up’ clickable 110 Prophesy ↑, and clickables 115 Exegesis→ and 116 TextVersions→ to his folders with the biblical reasoning used to decide the details, and with plain text descriptions of what the animations dramatise), the chapter animations 120 he had created earlier, and his new animation 125, highlighted as a current selection. Beside the folder are such clickables as an advertisement 160 from the site's sponsor, ways 150 to reach such services offered by the site as a “time remaining” calculator until the end of the Mayan, Unix and other calendars, or buy products such as T-shirts, and 130 a means to draw the attention of fellow members to the new upload, while offering them access to the upload, to the folder or to all of his space. These are not the concern of the present invention, save that by an evident use of the present invention “fellow members” may be extended to non-members merely by including their e-mail addresses, but provide an exemplary context.

Illustrative of the present invention, the button 140 offers him a way to invite non-members to the site in general, and to his own contributions in particular. To distinguish him from these users, we refer to him below as “the inviter”.

Upon a click (Drawing 2), button 140 becomes 240 a distinct color and exhibits a sub-menu 241 of further choices. A ‘radio button’ display in the standard visual format offers a choice between incompossible options 250, 251, 252 and 253; selecting one by a click (with results that include a ‘pushed in’ dot to show its status as selected) automatically deselects the others. The opening default is that button 250 is selected, so that if the sender clicks none of these buttons, the inviter will be giving an invitation and access permission to his whole personal space. If he clicks 251 the invitation will be to the folder containing his currently open one (here identified by the name “Prophesy” currently appropriate, rather than by a generic term like “superfolder”), if he clicks 252 it will be the currently open folder itself (identified according to our preference by the particular name “Jeremiah”, not as “this folder”), and if he clicks 253 the access offered will be only to his latest upload, or whatever is currently highlighted (which, by the clicking rules familiar to those skilled in the art, he can change). We assume in this illustration that he chooses the default, leaving the button 250 in the ‘pressed down’ state. If no item is selected, the button 253 is inactivated, either is not shown or appears ‘grayed out’, and does not have an accompanying text naming an item.

The box 260 invites the inviter to give an email address; The software may be able to access an address book on his computer or (for webmail) over the web, most commonly if he has entered some details and a password. In this case it allows him 261 to browse in it and click on the address or addresses he wants, using a drop down list or other such widget familiar to those skilled in the art. More typically, his mail client is guarded against such access, so this button does not appear: We take the case where Henry directly enters (371 in Drawing 3) the name and address of a non-member of doworryyourprettylittleheadaboutit.com named Cassandra Cassavetes, with address chicken.little@fallingfirmaments.com, the ‘invitee’. It is not mandatory that the inviter must enter a name, but in practise many emails give a name as well as an address, in a format such as ‘“Cassandra”<chicken.little@fallingfirmaments.com>’: assume for illustration that he pastes this into the box 261. If he enters only ‘chicken.little@fallingfirmaments.com’, the method includes small variations in what follows, which will be evident to one skilled in the art. The system does standard checks as to whether the format is one of these: if not, it prompts the user to revise the entry. As is clear to one skilled in the art, it may instead of a single recipient accept multiple entry sets, separated by commas or by semi-colons, pluralizing what follows.

By parsing the entry, then, the embodiment knows a name and perhaps an address. It opens a mail window, frame or other such area 400, inserting the invitee address or addresses 410 and salutation 411, with or without additional names between quotation marks. The said mail window may be opened directly by and under control of the embodiment, or the embodiment may, by means well known to those skilled in the art, cause to open a window in the user's mail client or webmail, and insert there entries discussed above, inviter information 420, and other such data as will be evident to one skilled in the art in the case of a particular embodiment. In either the mail client or webmail case, or the case of a window internal to the embodiment, it is preferred that the content of the three panes should be editable by the inviter. In a message pane 401 within the mail window 400 it inserts text such as that shown, preferably addressing the invitee by name 411 if available, mentioning and highlighting the specific item 430 to which the invitee is given access and optionally showing 421 the type of item in question, and making the item 430 a link such that if the invitee clicks on the said highlighted text the invitee's browser will receive and display a page containing the said item or immediate access to it (and optionally to other material).

When the sender clicks the Send button 440, the message is sent by the normal means to the email address of Cassandra Cassavetes, the exemplary invitee. This appears in the normal manner in the Inbox of her mail system, and upon opening presents the information of sender, addressee and content in the manner standard for that system. If she clicks upon the therein contained copy of the link 430, her web browser opens in the same or another window the display 500 provided by the present invention, preferably divided into two parts 510 and 550 but optionally replacing the part 550 by a button that takes the user to a view resembling the display shown here in part 550 but without the part 510.

The newly opened area 510 shows a view 511 of the item highlighted in Drawing 2, opened by the appropriate sub-system (in our exemplary case, a Flash plug-in of the browser). If in Drawing 2 no item was selected, a view similar to the pane 201 shows items now available for view or navigation. The area 510 also shows a number of navigation buttons and other facilities that are made available to the invitee by virtue of the invitation; 525 a button that opens Henry's DireWarnings folder, 521 a button that opens the sub-folder Jeremiah within that folder, 522 a pathway to Henry's postings in discussion groups, and 523 his blog. Many other such options are possible, depending upon the site and the services that it makes available, within the spirit of the present invention.

The newly opened area 510 exemplifies a core concept of the present invention. It gives access to the newly created home space DireWarnings of the invitee, who has already become a member of doworryyourprettylittleheadaboutit.com, subject to her consent. The welcome message addresses her 551 by the name associated with her e-mail address (if supplied), or failing that by her e-mail ID alone (in this case chicken.little) if that ID is not already in use by another member; in the latter case it would use her full e-mail address chicken.little@fallingfirmaments.com (by construction, unique worldwide). It also makes use 555 and 565 of the name of the inviter, available via the system database where it is linked with other ID labels and data.

From this space she has access to all the privileges appertaining to a basic level (non-paying) member of doworryyourprettylittleheadaboutit.com, such as via 560 to her home page, via 561 to a page where she can modify her name and other details, or upgrade to a paid account. She can reach 562 the home page of doworryyourprettylittleheadaboutit.com, navigate 563 to the list of blogs, see 564 the page with messages to and from other members, jump 565 to the highest access in the space of her inviter that he has offered her, or 566 to a list of members who have given her some access or vice versa (already including her inviter). The space may also give access to premium items offered on a promotional basis to new members, such as 570 live action footage of recent disturbing activities in the Cities of the Plain. She may be actively encouraged to continue the chain of invitations, with a link 580 to a personalised page similar to that in Drawing 2, with her home DireWarnings folder as the default replacement for the sub-folder shown there.

The Alerts button 567 may lead to a page where the member signs up to receive email that gives general site news or reports events of interest to the user, such as a new posting or an upload by a member in whom the user has registered an interest, or that invokes a user-registered key word or phrase such as ‘kali yuga’, ‘eschatology’, ‘antichrist’, ‘solar constant’, or ‘Microsoft’, or the arrival of a non-member whom the user has invited to membership, or many other event types depending upon the general functioning of the site. In addition or as an alternative, the page may enable the user to download a permanently active (but removable) ‘thin client’ program to the user's computer, independently of the browser, which regularly contacts the doworryyourprettylittleheadaboutit.com site and checks for such events, either reporting them instantly to the user or modifying the displays that it will show without web access delays, upon user input triggering such displays. Such a client may also perform other functions (such as opening a window that from a user viewpoint acts more like a folder in the user's operating system and less like a window or frame within a web browser), but the present invention addresses the enabling of multiple facets of the site for an invited user via a simple act by the inviter and a single click by the invitee. Installation of the client is thus beyond its purview, as is the client's functionality. Access to the installation via a button in a display such as 510 is precisely an exemplary instance of what the present invention makes possible, following immediately upon the invitee's single click on the link in the mail from the inviter and without intervening steps of registration, and—most critically—not as a step of registration before the user has learned to trust the site and find it useful.

The button 568 enables the new member, in her turn, to invite further new members. Clicking it opens a menu similar to the invitation process in Drawing 2, with the menu 241, but simpler because Cassandra does not have an elaborated folder structure, or uploaded items, to which to direct a new invitee.

As well as sending the invitation 401 illustrated in Drawing 4, the embodiment stores under a unique access number the data needed to create the page 500, including pointers to the inviter and invitee, the material the invitation covers and the material that the invitee may see. In our preferred embodiment the page 500 is not created as a static web page at this time, but exists in potential. The mail's highlighted link 430 is created by mark-up of a form such as (but not limited to) the HTML<a href=“http://doworryyourprettylittleheadaboutit.com/AJ723Z5.jsp”>Ezekiel/Chapter9</a>, where the exemplary element “AJ723Z5.jsp” is not the name of a static file but encodes the above-mentioned access number. (Other ways of embedding this information in the link will be evident to one skilled in the art, within the spirit of the present invention.) Upon receiving this link as a request from the browser, the server generates and sends the page 500.

An important security facet of the present invention, to be included in our preferred implementation, is that the link 430 does not create a permanent pathway by which other users can access the site and the material. We discuss here several means of handling continuing access: others will be evident to one skilled in the art, within the spirit of the present invention.

In a first embodiment of this security facet the link 430 may be used only a limited number n of times, where the value n=1 is preferred. The invitee may be informed of this limit in a number of ways, such as the request “So that you can return securely to our site, please think of a password and enter it here” attached to the entry box 590. Optionally, if the invitee shows interest in the site by clicking a button such as those displayed in Drawing 5 but has not yet entered a password, this may be reinforced by popping up the message window 600 shown in Drawing 6, which may also have an “OK” button by which it can be caused to disappear (but may reappear if the invitee again clicks a button without entering a password). By our preference, keyboard focus moves to the box 590, as signalled by the presence of a cursor 690 which may be made conspicuous by such means as blinking. If the invitee enters a password it is not displayed letter by letter but a new small window appears, requesting it be typed again, in the standard precaution against typing errors. If the two typed entries match, the result is stored as the user's access password until further notice, and the blocked button click takes effect. (If the invitee enters a password before clicking on a button, then the confirmation “please re-type” window appears, and upon a match the password is entered and any future button click will take unblocked effect.) In the case of mismatch, the invitee is invited to try again. Many other means of communicating to the invitee that this is a ‘use once’ (or ‘use at most n times’) link, including mention of this fact in the invitation, will be evident to one skilled in the art.

If the server receives a second (or (n+1)^{st}) request for the link 430 embedded in the invitation 401, it delivers a page similar to 700 in Drawing 7, explaining that the link 430 is no longer usable, and optionally containing a link 710 by which the user may register in the manner usual for any web site, and therefore not requiring further description here. It also optionally provides a link by which a user may contact the original inviter and request a new invitation to be sent to the invitee's email address. Various alternative measures by which the inviter may be assured that this request does come from the intended invitee, and not from some person or program that has captured the invitee's email access, will be evident to those skilled in the art.

In a second embodiment of this security facet the link 430 may be used an arbitrary number of times, but only from the machine and the browser from which it is used first. The user may still be invited to provide a password, which will enable use from any machine and any browser, in which case in our preferred embodiment the server will require the password each time the account is accessed. (An example where the user might prefer this option is when responding to the initial invitation from a shared machine or a cybercafe.) One means of implementing this feature by placing a ‘cookie’ in the browser's folder for such records will be evident to one skilled in the art. Certain users have their security settings adjusted to refuse cookies, which makes this method unviable. Therefore, the first time an invitee clicks on a button such as those shown in Drawing 5 for navigation within the site, our preferred embodiment checks the possibility of placing a cookie that will remain beyond the present session. If the browser will not permit this, the embodiment displays 800 a message box (Drawing 8) similarly placed to the message 600, encouraging 810 the invitee to provide a password before navigating away from the page with the box provided for this purpose. Optionally, it may indicate 820 that a bookmark on the current page will allow return: the embodiment must then arrange that the URL shown for the current page includes not only its location but permission data.

If the browser does permit permanent cookies, this still may be not be the invitee's method of choice for return to the site. In this case (Drawing 9), the first time an invitee clicks on a button such as those shown in Drawing 5 for navigation within the site, our preferred embodiment displays 900 a message box similarly placed to the message 600, giving 910 to the invitee the option of setting a password.

A third embodiment of this security facet of the present invention uses a sequence of new links. The link 430 may be used only once, but each time a user who has not set a password ends a session (by an overt logout mechanism, by closing all windows belonging to the site, or by inactivity for a set amount of time), the embodiment sends a new email as in Drawing 10 to the user's email address 1010, from an address 1020 at the site. By preference, it personalises 1011 the message to the particular user. The URL in the link 1030 contains a similar single-use key to that in the original invitation. Optionally, a link 1040 to a registration page is included, whereby the user can set up a password.

As these examples make clear, many ways to provide security of private access to the invitee may be included within the spirit of the present invention, avoiding the necessity that the invitee performs any of the currently standard means of establishing an identity with the web site.

### Application to Multiple Types of Site

This method may be applied, with modifications evident to any skilled in the art, to sites offering very various suites of services. With exemplary rather than exhaustive intent, we list some of these below. In many cases it will be clear to be persons skilled in the art that the application may equally be for a site existing on a restricted intranet, associated with a college, company or other entity, as to a site on the World Wide Web.

Document access site: Many sites provide access to scholarly, legal or other documents, with either download from their own servers (such as those of professional societies) or navigation help in finding the documents elsewhere. In many cases access to documents, or even to search tools to find them, is restricted to registered members. It may be free, or there may be a membership or per-document charge. The membership base is in any case of benefit to the site owner, who can among other uses found advertising and promotion strategies on it. A means of encouraging such membership is therefore of value.

Not all the services offered by doworryyourprettylittleheadaboutit.com above are appropriate to such sites: for example, many do not provide space for upload. Alerts for various events (such as the availability of a new document matching the member's registered preference as to author, keywords, or other criteria), on the other hand, are natural for such a site. The particular mix of services to which the invited member will have access, then, varies with the site. The general invitational method described above remains useful, with an emphasis on what the inviter has found and may wish the invitee to see. Commonly in present practice, a member of such a site will download a document and share it by e-mail with friends. Rights management technology will for some time have its limits, so a copyright-conscious site owner cannot prevent this sharing; by the present invention the site can at least increase its membership, by including the document in an invitation transaction. Rather than follow the sequence ‘download, open mail, attach file, hit send,’ and often ‘try again because the mail server is having trouble with attachments’ an unpredictable number of times, while on the site a subscribing member clicks a “share this document” button and enters an email address, similarly to the invitation process in Drawing 2 with modifications evident to one skilled in the art. The receiver gets email inviting a direct download, generally a more trouble-free process than receiving an attachment, and acquires a basic level membership of the site in the process. (In our preferred embodiment, if the receiver simply performs the download without entering a password to enable return, this membership is erased.) Both users gain, and the site has a significant chance of increase in its member base. Optionally the member may be limited as to the number of sharings on a particular document, or in a particular time period.

The new member may be encouraged to sign up for alerts or a regular newsletter, to mount a remote folder or drive, to install a thin client, or to enter personal details such as education and employment, but these have been detached from the recruitment process per se. The site manager to whom these things are important now has the task of causing already-recruited members (new or long-established) to sign up for them, rather than enforcing sign-up at the recruitment stage. There will be some members who while working through a multi-page registration would have signed up—or accepted defaults—on a why-not basis or out of curiosity or puzzlement, but such members rarely actually use these services. A member who joins the site itself by the present invention's simple path may never get around to signing up for these services, but would often have been only a listed but inactive user of the services if enrolled in the current way. (If such a service is an advertising newsletter, it usually submerges in the user's existing junk mail load.) Other potential members deterred by a complex enrolment process, and lost altogether to the site, are a more serious deficit than those who miss a service sign-up. The logic of the present invention places a higher value on the first step of membership, and prepares site managers for the subsequent work of promoting features one by one (with more opportunity to explain their advantages).

Paid viewing site: Paid viewing has been a major motor of internet growth as a medium for sexually explicit images, primarily because of their limited availability by other means. Matter which could be openly rented or borrowed on a tape or disk has usually been obtained that way, for their superior sound and visual quality. Improved bandwidth and compression technology, however, may soon make ‘video on demand’ the preferred access path for general home viewing, either on a streaming basis (view once, often with technology that seeks to prevent permanent storage) or download (often with technology that seeks to limit the machines allowed to play the copy). This will make a second explosion in internet use, with distribution sites in vigorous competition for the market in films of all kinds, music videos, documentaries, etc. Most will seek to build customer loyalty by site membership, and the present invention will be of great utility to them. A typical use of the invention, for such sites, will enable a subscribing member to invite a friend to see a movie or clip that the member has enjoyed: friends know their friends' tastes better than a demographic profile can know them, so this is well targeted. The inviter sends a letter (via the site, or with the site invoking the inviter's e-mail system, as above), which contains a link to the site. The invitee receives this, clicks the link, has a fully legal opportunity to see or download the item, and in the process becomes a basic member (often with some sign-up bonuses of access to material normally available for payment). The fictional doworryyourprettyheadaboutit.com example site example above makes evident to those skilled in the art, the manner of implementing this.

Community site: For a community site, membership is primary. Its principal function is to enable communication between members, whether by direct messaging, posts placed in one another's open ‘scrap books’ or similar spaces, or by posting in discussion groups. Some target general chat, some imitate a singles bar or a spaceport waiting room, while others seek to enable scholarly discussion, but the structure is similar. (Often a community site can be a sub-section of one of the other types here discussed.) It is common for such community site to enable a member of a discussion group to invite other members of the site, but the active support of the present invention for a site member inviting a non-member to join the site, beyond merely passing to the non-member the URL of the registration page, has been absent. As will be evident to one skilled in the art, by means of the present invention the inviter may invite the invitee simultaneously to the site and to the discussion group, with the invitee already a member of the group upon becoming a member of the site, without additional steps.

Document-sharing site: As noted above, download and upload are often easier than sending and receiving an attachment. A site or sub-site dedicated to this function can allow a member to create folders (as in the above case of doworryyourprettylittleheadaboutit.com), upload and download files to and from them (preferably by a simple ‘drag and drop’ rather than a menu process), and grant access to other members, who are automatically notified (by email or by a thin-client alert process) of new folders to which they have access or new files in folders already open to them. The site may also provide support in the management of successive revisions of a document, relationship of grouped documents, possible name space conflicts if the documents are program source code, etc., but this is outside the purview of the present invention.

In many cases the appropriate implementation requires that the user installs either a thin client (a small program resident on the user's computer), or mounts a ‘remote drive’ over an intranet or the external web. The user has to do a sequence of operations specific to the OS and the connection (FTP, WebDAV, Samba, etc.). For example, to install a remote drive under Windows XP a user must create a network shortcut to the remote drive in the Explorer window, while via Linux there are graphical and command-line based WebDAV clients that are configured to allow access to the remote drive as an extension of the local drive. To get past the firewall or other defenses set up by a company or institution may require additional steps, often requiring expert help. Under Mac OSX (perhaps the simplest) the user must click to make the Finder menu visible, click the oddly named “Go”, and click on “Connect to Server”. A window opens with a small “Server Address” box and a bigger one called “Favorite Servers”; the user must type or paste the server address into the right one of these, then hit Enter, and so on. To a programmer this sequence of a half dozen steps is almost mindlessly simple, and fully described by “Select the ‘Connect to Server’ option in your Finder and enter the address”. To the typical user each step is mysterious, full of options (why “Go” rather than “Finder” or “File”?) that only experiment can resolve, and fraught with unknown risks for any wrong choice. This raises both the actual click count and the user's anxiety level.

Few among the many non-technical users of personal computers are familiar with any ‘mounting’ process, or expect success with one, and the psychological barrier is thus high. A third-party thin client, as a document sharing site might provide to its users as a means of delivering service, needs download and installation, often with the OS asking scary questions about whether this software comes from a trusted source (and user trust even in global IT brands has been diminishing). A new service has had little chance to build trust. Evidently both the processes and the user guidance should be made clearer than they now are, but this is not the topic of the present invention.

With any delivery means, then, a document-sharing service faces a barrier in recruiting new users by (for example) advertisements, which must lure to the site a potential recruit despite both the difficulty and the unease of installation or preference-setting on a local machine. By the present invention, the psychological barrier is not encountered ‘cold’ but in the context of an invitation from a colleague and collaborator, typically to join in work upon a specific project. This contrasts sharply with advertisements that claim that “Use X, collaboration will be easier” (devalued by remembered collaboration nightmares with widely promoted office suites), and even to a recommendation from a colleague (who may be seen as more computer-savvy, skipping over such problems: “But, could I use it?”). The moment of starting a joint project, which the user has a professional or other interest in taking forward, is the point of highest motivation to join a collaboration system, and do whatever installation or preference-setting is necessary. Indeed, some users will be motivated to take these steps to avoid loss of face (“sorry, I just couldn't get it working” sounds weak) or to accept the need for help (“sorry, I just can't get this working, can you talk me through it?”), in either case resulting in successful recruitment. “I have an urgent file waiting for me” is a spur to the non-technical. Learning a ‘cool’ new trick is not.

The invitation sets up a great deal of detail automatically. Whatever can be done without invitee input, using only inviter input of the invitee e-mail address and of the folder to which the invitation gives access, is so done. The invitee's experience of being active in the system is thus immediate and positive, improving the sense of being at home in it. The fact of simultaneously acquiring a home space (analogous of MyDireWarnings in the exemplary web site described above), and the live example of how the inviter's membership works, encourages the invitee to start active use beyond the particular project. The one-click nature of inviting further non-members, to participate in the original inviter's project (if the server does not restrict this right to the originator, which is an option that in some embodiments the inviter may set) or to participate in new projects originated by the new member, raises the likelihood that this new member will in turn issue effective invitations. A similar logic of recruitment enhancement applies to many of the other applications of the present invention, as discussed in the preceding and following examples and in others that will be evident to those skilled in the art.

Besides the motivational enhancement for new members completing the enrolment process, the invitational model allows simplification of their enrolment task, as exemplified in the steps sequence and step by step guidance it makes possible for various embodiments. Regardless of the method of file access selected (FTP, WebDAV, etc), the proposed system makes an icon available in each folder that gives users immediate access to the management controls for that folder. The controls may be in the form of a web page with stepwise instructions allowing the owner to invite and reject other users to access the folder. Our preferred embodiment has instructions and control software that control access to a given folder always present with that folder, avoiding the need for the user to maintain one mental picture of where the folder is, and another notion of where its controls are.

In a particularly preferred embodiment, the folder appears within the web page in a style similar to the style of folders in the OS the user connects from (Windows 2000, XP or Vista, Mac OSX, etc.), which can be detected by means well known to those skilled in the art, and interacts with the user similarly to the interaction style of those folders. (For example, it should be possible to drag and drop items between the web folder and a folder of the local OS.) An option on display suggests “Move this folder to your desktop” or similar words, which according to the OS and operating details may involve installing a remote drive or a thin client. The user is not required to do this, but after gaining experience with the services of the sharing site may choose to do so. At this point, with the user highly motivated, the site offers step by step instructions on what is to be done.

These are exemplary illustrations rather than an exhaustive list of remote access methods and their simplification by the present invention. Analogous application of the spirit of the present invention to many such methods will be clear from these examples to one skilled in the art.

The method thus (for the inviter) simplifies inviting, and (for the invitee) both motivates and simplifies enrolment. It increases the rate of further invitations and the growth of the site.

In the typical project workflow, a project leader or a secretary may create a new folder, perhaps place in it one or more first document drafts, and list the persons to have access to the folder. By means of the present invention, this process is unified, not requiring that all potential members of the group become site members in advance: non-site-members can be included in the same notification process simply by including their email addresses in the circulation list, in an adaptation of Drawing 2 that will be evident to one with skill in the art. Since the site's database contains an e-mail address for every member, and since these constitute identity keys unique on a planetary basis, the folder creator need only enter (by typing, cut and paste, or selection from an address list) the e-mail addresses of those who are to be invited to the document group. Those group invitees who are already site members receive a notification that less resembles the invitational email in Drawing 4, and log in to the site without seeing a welcome page like Drawing 5, but no difference is visible to the group organizer. The present invention thus simplifies not only the process of site recruitment, but also the workflow of the site's users, to the benefit of all concerned.

Etail site: Many web sites that sell merchandise encourage their customers to register for some form of membership, to receive e-mail alerts or for other purposes. The current sign-up page for Amazon.com has a sign-up page with seven boxes, that for Victoria's Secret has fifteen. In an application of the present invention, an existing registered customer can (by entering an email address in a form like Drawing 4) trigger a one-click-plus-password-entry enrolment process for a friend. In our preferred embodiment, this capability is attached to every item in the on-line catalog, so that the member can send to a friend the message that “You really should read this” or “This is the ideal prosthetic hand to improve your backswing” or “you would look particularly great in the mauve version of this—I'd buy it for you but don't know your ankle size”, etc., as appropriate, with an embedded link that brings up the catalog account of the item in a pane analogous to 510 and an enrolment pane analogous to 520, in a manner evident to one skilled in the art. This application of the present invention thus joins highly targeted electronic ‘word of mouth’ advertising for the specific item with ‘viral marketing’ of the site as a whole. It twice over involves the recommending customer in promoting the site owner's interests, and performs a service to both consumers involved.

News site: Most news sites, such as but not limited to the web sites of newspapers and radio or television stations, attach to every page a ‘mail this story’ button. Many news sites require a registration process (usually free) for those wishing to read any article. As a result, when ‘mail this story’ means in practice ‘mail a link’, a receiver must often go through the registration process before seeing the story that was ‘mailed’ by the sender. An invitational message, as disclosed in the present invention, can streamline this process while preserving the site's goal of recruitment—indeed, fewer recipients drop out at the stage of seeing a registration form.

Many news sites allow free access to recent or headline stories, but seek payment for deeper use. For example, premium (paid) membership may be required to read a story that was archived more than seven days before the current date, or such material may be made readable on a pay-per-item basis. As with a document site, the user may by the present invention combine a site recruitment message with the free sharing of an item obtained by paid access, at reduced inconvenience to both sharer and recipient.

Genealogy site: The registration form for MyTrees.com, typically for such sites, has eleven boxes to be filled. (It also has enough instructions about enabling SSL 2.0 to deter many non-technical users.) Family tree building is pre-eminently a co-operative enterprise. A user often wishes to involve semi-distant relatives, so as to include their family data. Genealogy software aims to simplify the codification of such data. A long, confusing e-mail dialog with Great-Uncle Sven can thus be eased if he can be persuaded to enter the data directly, rather than reminisce; but for this, he must be introduced to the site. The present invention, by which the invitation itself makes him a member, is far more great-uncle-friendly than directing him to the URL of the registration page, after which he must be led to the page containing the page his great-niece is building. An invitation sent to him by selecting his name on the tree as already constructed, and supplying his e-mail address, can deliver him not only to immediate membership but to a page showing (centered on himself) those relatives already known to his great-niece, with instructions on how to add or modify names, relationships, and other data. This smoother recruitment process is of evident benefit to all involved.

Cartoon site: Many web sites show ‘web comics’, static cartoons drawn or otherwise created by artists specifically for the web, or provide web access to such material appearing in newspapers. Some such sites require membership, and certain sites require payment for membership. In an application of the present invention, in both cases an existing member with a page open at a particular comic may send an invitation to a non-member who may click on a link and see that comic, acquiring also such membership privileges as the site's policy may permit.

As demonstrated by the above variety of sites to which the method here disclosed may be adapted, those skilled in the art will find many other such applications of the present invention to web sites of many other types, within the spirit of the present invention.

### Logical Flow of the Invention

Drawing 11 shows the steps in an exemplary embodiment of the present invention. In step 1101 a user logs into the site, either 1103 returning to the site, or 1104 as a consequence of newly becoming a member. There are standard implementations for both of these mechanisms, which we therefore need not detail here (though steps 1146 to 1158 below give two standard return log-in mechanisms, following two embodiments of the invitational aspect of the present invention). Alternatively, steps 1166 to 1199 (numerically inclusively) below represents novel means for the return log-in process. New member registration may occur by the currently standard means, well know to those skilled in the art, or by steps 1130 to 1134 for an invited new member, according to the present invention. Either 1103 or 1104 leads to the logged-in state, where 1109 the site displays the invitation icon exemplified by 140 in Drawing 1 or 568 in Drawing 5.

We note that if sharing material is treated as a matter requiring authorization, the user inconvenience of this requirement may be reduced by passing a token with such authorization directly or indirectly embedded.

After a variable interim 1111 during which the member may use any of the services that the site supports, such as uploading or downloading files, searching, etc., the member may click 1120 on the invitation icon just mentioned, upon which the site displays 1121 an invitation from such as 241. The user joins 1122 a dialogue to select (from persons known to the site) or enter (new persons, by e-mail address) the person or persons to be invited. For fellow members the site may inform them of a viewing invitation by means within the system, but even in this case our preferred embodiment sends e-mail to the invitees, since many users check e-mail more often than any other service. For the remainder of this disclosure we assume that abbn invitee is not already a member of the site, making e-mail the communication pathway of choice, and describe the flow of their joining it.

In step 1130 the invitee opens the invitational e-mail, and 1131 clicks the link 430 contained in it. The site receives a browser request in the normal way, verifies that this link (including embedded data) has not already been used, and uses the data coded in the request to locate the inviter, the invitee and parameters such as what the invitee is invited and permitted to view. The site uses this information to create 1133 a membership record for the invitee, with a home space and appropriate access permissions, and 1134 displays the new space to the new member as in Drawing 5.

At this point different pathways may be followed in consolidating and prolonging membership.

The new member may 1140 set a password memorable to and private to that member, and in some embodiments may (not shown) mount a remote folder or install a thin client for access to the site. After perhaps further interaction with the site, the user exits 1141. When she returns 1146, by directing her browser to a bookmark, by activating an operating system icon for a remote folder, by opening a thin client on her local computer, or by such other means as will be evident to one skilled in the art, the site 1146 demands (through the contact just re-initiated) an identity and password. The member, or the thin client as her representative, enters these data by the means appropriate to the medium. (In the case of browser contact, for example, the browser may remember and fill in the name and password, but the user is expected to click a Login button or press an Enter key.) If 1149 the site accepts the data as representing a valid account, it completes the log-in process.

In an alternative widely used by (for instance) news media sites, the web server puts 1150 a cookie on the user's local computer, to permit return. After perhaps further interaction with the site, the user exits 1151. When she returns 1156, using the same computer, the site reads 1157 the cookie, 1158 accepts it, and grants access without further troubling the member.

In a further alternative which forms part of the present invention, the site mails 1160 a new link, similar to the original invitation, to the member, new or returning. This is shown as immediate, but could be immediately subsequent to the user's exit 1161 from the site. (This puts security responsibility on the user's mail system, but with less risk than—for example—the common practice of mailing a password which may remain on the mail system and be usable until actively changed. This link, like the one clicked in step 1131, is ‘use once’, and invalid after step 1168. A security breach would thus have to be specifically of recent, not archived, mail.) When the user clicks 1166 on the new link in the new e-mail, the site 1167 reads the data embedded in the new browser request and verifies that the data are valid for a returning member and have not been previously used. It then 1168 accepts the access.

Each of these pathways, and others within the spirit of the present invention that will be evident to one skilled in the art, yield 1199 the situation of the returning member logged in for a new session, with all the displays, services, etc., associate therewith.

The above description is offered with exemplary intent, and does not exclude many minor variations within the spirit of the present invention that are possible and apparent to one skilled in the art.
An embodiment discloses a computerized method for invitational recruitment to a web site, comprising the steps of
   a) Offering an existing member a means to invite a non-member to join, by entering email data for the said non-member;
   b) Sending an e-mail to the invitee, containing a web link;
   c) Using the invitee's email data to create a provisional member ID for the invitee;
   d) The first time the link is used, opening a member page for the invitee.
An embodiment discloses a method wherein step (a) the inviter also specifies certain privileges beyond basic membership in the site, that will be afforded to the invitee.
An embodiment discloses a method where the privileges give access to folders created by the inviter.
An embodiment discloses a method where the privileges include download access to material uploaded or posted by the inviter.
An embodiment discloses a method where the privileges include download access to material in folders created by the inviter.
An embodiment discloses a method where the privileges include download access to material in folders to which the inviter has access.
An embodiment discloses a method where material on the server of the web site is shown to the user by icons in a window that appears and is controlled as a folder in the user's local file hierarchy.
An embodiment discloses a method where instructions specific to the said folder appear in its menus and bar.
An embodiment discloses a method where the privileges include sharing in access to existing material on the site for which the cost is borne by the inviter.
An embodiment discloses a method where the privileges include sharing in genealogical data assembled by a group of which the inviter is a member.
An embodiment discloses a method where the members of the web site access it via a web browser.
An embodiment discloses a method where the members of the web site may install a thin client on their own machines for improved interaction with its services.
An embodiment discloses a method where in step (a) the inviter also specifies certain options available to basic members to which the invitee will be specifically directed upon first entry.
An embodiment discloses a method where the options include membership of a group.
An embodiment discloses a method where the options include a view of specific site material accessible to all members.
An embodiment discloses a method where the said material is a news report.
An embodiment discloses a method where the said material is material posted or uploaded by the inviter.
An embodiment discloses a method where the said material is a description of merchandise for sale.
An embodiment discloses a method where after a specified number of uses the link opens only to a page leading to an invitation to register directly, and optionally to a request for a new invitation as in Claim 1(a).
An embodiment discloses a method where the specified number is one.
An embodiment discloses a method where the site confirms the invitee's consent by obtaining a password chosen by the said invitee.
An embodiment discloses a method where any attempt to navigate in the site without choosing and entering a password for permanent access is met by refusal until a password is entered.
An embodiment discloses a method where after one use the link becomes invalid, but a new single-use link is sent to the user, permitting access without a password to the user's space on the site.
An embodiment discloses a method where after one use the link becomes invalid, but use of a cookie permits repeated access without a password to the user's space on the site when using the same machine and browser.
An embodiment discloses a method where the window first appears to the user within a browser, from which the user is enabled to transfer it (visually and interactionally unchanged) to a position in the local file hierarchy.

What is claimed is:

1. A method for invitational recruitment to a web site over a network, under control of a computer system, comprising the steps of
providing an existing member of the web site with an inviting arrangement for inviting a non-member to join the web site wherein the inviting arrangement comprises an input arrangement wherein the existing member is enabled to enter non-member data;
entering non-member data to be used to establish a communication with the non-member;
sending a first message to the non-member, containing a web link to a member page for the non-member, using the entered non-member data;
creating a provisional member ID for the non-member based on the non-member data, enabling access for the non-member to the member page; and
storing the provisional member ID at the computer system.

2. A method according to claim 1, wherein the method further comprises the step of:
setting a parameter that must be fulfilled such that access to the member page is limited to a request that fulfills the set parameter
activating the link wherein a second message is created comprising a browser request with the address of the link along with the non-member data,
transferring the second message to the web site,
identifying sender of the second message using the provisional member ID to allow access to the member site, and
displaying the member site if the second message fulfils the set parameter.

3. A method according to claim 2, wherein the parameter to access the member page comprises a limit of times to use the link.

4. A method according to claim 2, wherein the parameter to access the member page is a password.

5. A method according to claim 1, wherein the non-member data comprises an email address of the non-member.

6. A method according to claim 1, where the inviting arrangement comprises a second input arrangement wherein the existing member is enabled to specify at least one privileges beyond a basic membership in the site that will be afforded to the non-member.

7. A method according to claim 6, where one privilege gives access to at least one folders created by the existing member, allowing reading or download of data in the folders.

8. A method according to claim 6, where one privilege includes enabling the non-member to download access to material uploaded or posted by the existing member, or to which the existing member has access.

9. A method according to claim 6, where one privilege includes sharing in access paid for by the existing member to existing material on the site.

10. A method according to claim 6, where material on the server of the web site is shown to a user by icons in a window that appears and is controlled as a folder in the user's local file hierarchy.

11. A method according to claim 10, wherein instructions, specific to the folder in a user's local file hierarchy, appear in its menus and bar.

12. A method according to claim 6, where one privilege includes sharing in genealogical data assembled by a group of which the existing member is a member.

13. A method according to claim 1, where the members of the web site may install a thin client on their own machines for improved interaction with its services.

14. A method according to claim 1, where in the step of entering the non-member data also comprises that the inviter specifies certain options available to basic members to which the non-member is to be specifically directed upon first entry.

15. A method according to claim 1, where after the link is used a specified number of uses indicated by the parameter the link opens only to a page leading to an invitation to register directly, and optionally to a request for a new invitation.

16. A method according to claim 1, where the site confirms the non-member's consent by obtaining a password chosen by the non-member.

17. A method according to claim 1, where after one use the link becomes invalid, but a message with a new single-use link is sent to the user to whom the link was sent, permitting access without a password to the user's space on the site.

18. A method according to claim 1, where after one use the link becomes invalid, but use of a cookie permits repeated access without a password to the user's space on the site when using the same machine and browser.

19. A method according to claim 10, where the window first appears to the user within a browser, from which the user is enabled to transfer it (visually and interactionally unchanged) to a position in the local file hierarchy.

20. A database comprising a memory arrangement containing a web site, so arranged as to enable the database to be connected via a network to a computer of a member of a web site, and a control unit, wherein the control unit is arranged to, when running an application from the memory arrangement,
provide an existing member of the web site with an inviting arrangement configured to invite a non-member to join the web site wherein the inviting arrangement comprises an input arrangement wherein the existing member is enabled to input non-member data to be used to establish a communication with the non-member;
send a first message to the non-member, containing a web link to a member page for the non-member, by using the entered non-member data;
create a provisional member ID for the non-member based on the non-member data, wherein the provisional member ID is arranged to enable access for the non-member to the member page;
set a parameter value that needs to be fulfilled to enable the access to the member page; and
store the provisional member ID along with the set parameter in the memory arrangement.

21. A database according to claim 20, wherein the control unit is further arranged to check whether a received request fulfils the parameter and to provide access to the member's page.

22. A database according to claim 20, wherein the parameter is set to be or include a maximum number of activations of the web-link and/or a password.

23. A computer program product including a computer usable medium having computer program logic stored therein to enable a computer system to perform the steps of offering an existing member of a web site an inviting arrangement to invite a non-member to join, by entering email data for the non-member, sending an e-mail to the non-member, containing a web link to a member page for the non-member, and using the email data of the non-member to create a provisional member ID for the non-member enabling access to the member page.
